(19) United States
(12) Patent Application Publication
(10) Pub. No.: US 2008/0297313 A1
(43) Pub. Date: Dec. 4, 2008

(54) System Provided With Several Electronic Devices and a Security Module

(76) Inventors: Klaus Kinkenzeller, Unterfohring (DE); Florian Gawlas, Munchen (DE); Gisela Meister, Munchen (DE)

Correspondence Address: BACON & THOMAS, PLLC, 625 SLATERS LANE, FOURTH FLOOR, ALEXANDRIA, VA, 22314-1176, US

(21) Appl. No.: 11/988,089

(22) PCT Filed: Jul. 5, 2006
(86) PCT No.: PCT/EP2006/006565

§ 371 Date: Jul. 14, 2008

(30) Foreign Application Priority Data
Jul. 6, 2005 (DE) 10 2005 031 629.8

(51) Int. Cl. H04Q 5/22

(52) U.S. Cl. 340/10.1

(57) ABSTRACT

The invention relates to a system with a first electronic device (2), a security module (1) and a second electronic device (9, 10, 14, 21). The security module (1) is firmly bound to the first electronic device (2) and has a security unit (3) for securely storing data and/or for executing cryptographic operations and a first interface (4) for communicating with the first electronic device (2). The system according to the invention is characterized in that the security module (1) has a second interface for the direct contactless communication with the second electronic device (9, 10, 14, 21).

The invention relates to a system with a plurality of electronic devices and a security module which is firmly bound to one of the electronic devices. Furthermore, the invention relates to an electronic device with a security module which is firmly bound to the electronic device.

It is already known to provide a computer system with a security module, which is formed as a security chip firmly bound to the computer system. Such a security module is also referred to as trusted platform module, abbreviated TPM, when it conforms to the specifications of the Trusted Computing Group (TGC). These specifications permit a defined security standard.

With the help of the security module the computer system can be identified as trustworthy and can be protected against manipulations. This is of interest in particular when security-relevant operations are to be carried out with such computer system.

The security module can be addressed by the operating system or the application software of the computer system via a defined interface. For example, the security module can be used as a secure memory, i.e. protected against unauthorized access. Here in particular the state of the computer system can be stored in the security module. The stored state of the computer system can be requested by a third party, for example a server. In order to ensure in a fashion trustworthy for the receptor that the data transmitted to the receptor were not manipulated, the security module can carry out an authentic transmission for example with an RSA signature function. In addition, the security module can serve for executing further cryptographic algorithms, such as for example HMAC, generating random numbers etc.

With the known security modules it is already possible to protect a computer system in a highly effective fashion. But, however, a failure or a manipulation of the computer system may lead to the fact, that the security module does not supply any useful information and, consequently, the actual state of the computer system cannot be determined with the help of the security module. A willfully caused failure of the security module in conjunction with further manipulations could potentially even be used to pretend a proper function to a third party accessing it.

Furthermore, from WO 00/14984 A is known a security module which serves to authenticate to each other two electronic devices, for instance a mobile telephone and a bank terminal, and to secure the communication between the two by encryption, so that therewith for example the carrying out of a secure transaction to a bank terminal per mobile phone is permitted. The security module has a first interface for the connection with a first device, for instance a mobile telephone, and a second interface, in particular formed as a bluetooth interface, for the communication with a second electronic device, for instance a corresponding security module in a bank terminal. For using it the security module is connected with one of the devices, for instance a mobile telephone, with the help of which a user then starts a communication with another device, for instance a bank terminal, and carries out e.g. a transaction. Here the security module acts as a secure intermediary.

The invention is based on the problem to reliably ensure the usability of a security module firmly bound to an electronic device.

This problem is solved by a system with the feature combination of claim 1 and an electronic device according to claim 21.

The system according to the invention has a first electronic device, a security module and a second electronic device. The security module is firmly bound to the first electronic device and has a security unit for securely storing data and/or for executing cryptographic operations and a first interface for communicating with the first electronic device. The characteristic feature of the system according to the invention is that the security module has a second interface for autonomously carrying out a direct contactless communication with the second electronic device. The second electronic device in particular can be an external device.

The invention has the advantage, that the possibility of the second electronic device communicating with the security module of the first electronic device is reliably ensured. Since it is effected independently of the connection between the first electronic device and security module, such communication is still possible and trustworthy in particular in case of a manipulation or a failure of the first electronic device and can be carried out in a standardized fashion. This means that with the help of the security module the trustworthiness of the first electronic device is checkable on a high security level.

Preferably, the first interface is galvanically connected to the first electronic device.

The second interface can be formed as an integral part of the security unit.

In a first variant the second interface is formed as a passive contactless interface. This has the advantage, that even in case of a total failure of the first electronic device the security module is still operational and can communicate with the second electronic device. Here there is the possibility that the energy required for the operation is contactlessly supplied to the security module via the passive contactless interface. With that the security module can be operated even when the first electronic device does not supply any operating voltage to it.

In a second variant the second interface is formed as an active contactless interface. By this means a communication with a second electronic device is permitted, which itself is not able to produce a field for the contactless data transmission. It is especially advantageous, when the active contactless interface is operable in different communication modes. This permits a communication with differently formed communication partners.

It is also possible, that the security module has a passive contactless interface and an active contactless interface. This has the advantage, that the advantages of the two interface variants can be used. Here the security module can have a control device for selectively activating the passive contactless interface or the active contactless interface. In particular the control device can effect the activating dependent on whether to the security module is supplied an operating voltage from the first electronic device. With that it can be ensured for example that in case of an outage of the operating voltage the security module is still accessible via the passive contactless interface.

The active contactless interface is preferably formed according to the NFC standard.

Via the second interface for example data stored in the security unit can be transmitted to the second electronic device. In particular such data can be diagnosis data of the first electronic device or cryptographic data. Furthermore, there can be provided that the data are transmitted only when the first electronic device and the second electronic device are members of a group of electronic devices for which a data transmission between one another was released. In this way an uncomplicated data transmission between electronic devices can be carried out which for example belong to the same person.

The second electronic device can have a security module, which directly contactlessly communicates with the security module of the first electronic device.

Via the second interface, for example, cashless payment transactions can be effected, with which authorizations stored in the security unit are acquired. It is also possible, that a password entered into the second electronic device is transmitted via the second interface to the security module of the first electronic device.

The first electronic device for example can be a computer or a mobile telephone. The second electronic device for example can be an RFID reading device, an NFC device, a contactless chip card, a computer or a mobile telephone. The security module preferably is formed as a trusted platform module.

The invention further relates to an electronic device with a security module which is firmly bound to the electronic device. The security module has a security unit for securely storing data and/or for executing cryptographic operations and a first interface for communicating with the electronic device. The characteristic feature of the electronic device according to the invention is that the security module has a second interface for autonomously carrying out an external contactless communication independent of the electronic device.

In the following the invention is explained with reference to the embodiments represented in the Figure.

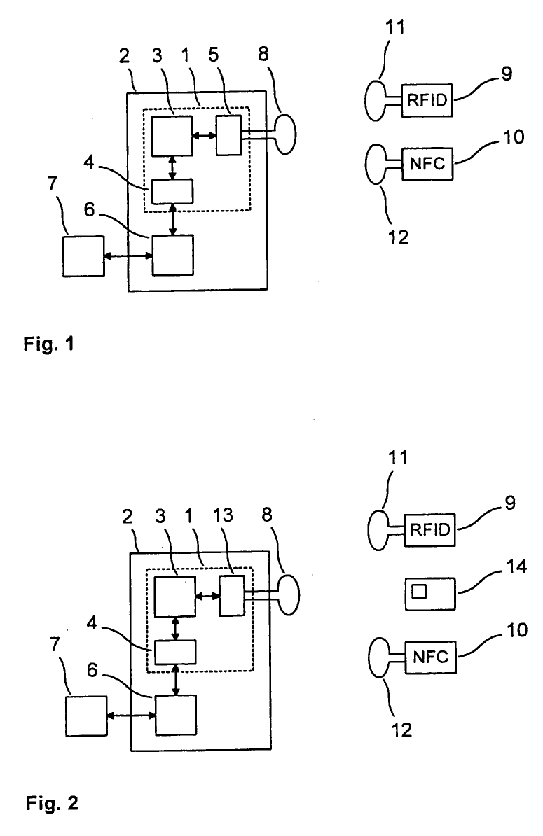

FIG. 1 shows a schematic diagram of a first embodiment of a system with a security module formed according to the invention,

FIG. 2 shows a schematic diagram of a second embodiment of a system with the security module,

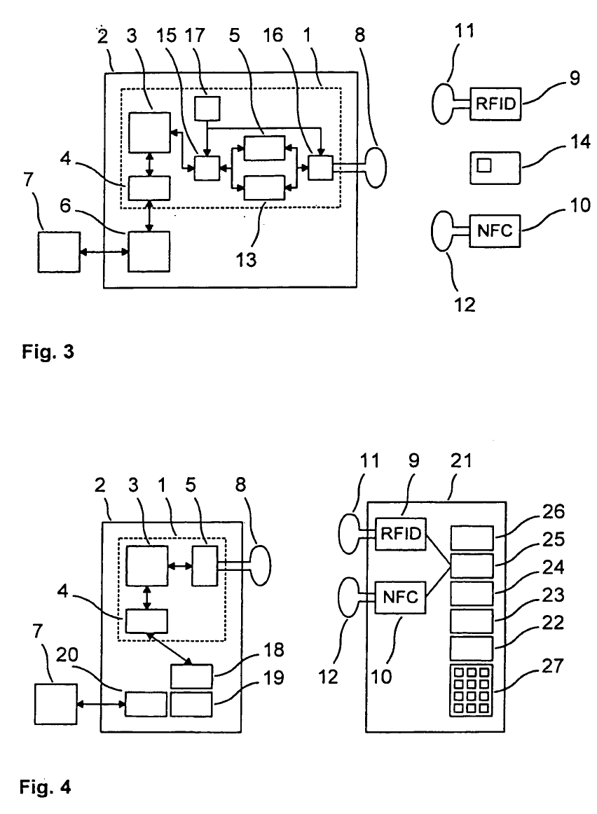

FIG. 3 shows a schematic diagram of a third embodiment of a system with the security module and

FIG. 4 shows a schematic diagram of a fourth embodiment of a system with the security module.

FIG. 1 shows a schematic diagram of a first embodiment of a system having a security module 1 formed according to the invention. Security module 1 is formed as a component of an electronic device 2, for example a personal computer, a personal digital assistant (PDA) or a mobile telephone, and has a security unit 3, a device interface 4 and a passive contactless interface 5. Security unit 3 provides a variety of security functionalities, such as for example storing data safe from access, executing cryptographic operations etc according to the specifications of the Trusted Computing Group (TGC), so that the security module 1 can be employed as a trusted platform module (TPM). Therefore, with the help of the security module 1 in the electronic device 2, which taken alone is insecure, can be implemented a certain security standard.

Device interface 4 and passive contactless interface 5 each are connected with security unit 3. Via device interface 4 there exists a communication connection to a software 6 of the electronic device 2. Software 6 of electronic device 2 for example is an operating system or an application. The communication connection is formed as a galvanic connection, for example, to a mother board of the personal computer, to a microprocessor of the PDA or to a controller of the mobile telephone. Via this communication connection in particular there is effected a communication of security unit 3 with software 6 of electronic device 2 required for ensuring the trustworthiness of electronic device 2. Furthermore, a connection to a network 7, for example the internet, can be set up via such communication connection.

Via the passive contactless interface 5 there can be set up a communication connection for carrying out a communication with a second electronic device 9, 10, which is independent of the communication connection of the device interface 4. Because of the independence of the two communication connections, carrying out a communication via the passive contactless interface 5 can be effected autonomously. Among other things, a communication via interface 5 can be carried out at any point of time. The second electronic device 9, 10 can be an external device. To the passive contactless interface 5 an antenna coil 8 is connected for the contactless communication. Antenna coil 8 can be disposed directly on the security module 1, which for example has the form of a security chip. Antennas applied onto semiconductor chips taken alone are known as “coil on chip”. In this embodiment of the antenna coil 8 the range of the contactless communication is very small and normally limited to a range of between some millimeters and some centimeters. Therefore, with larger electronic devices 2 it may be required, that at first electronic device 2 has to be mechanically opened, in order to permit that an external communication partner can contactlessly communicate with the security module 1.

Alternatively to the arrangement directly on the security module 1, the antenna coil 8 can also be mounted at a well accessible position of the electronic device 2 and connected via a cable connection, for example a coaxial line, with passive contactless interface 5 of security module 1. A possible place of incorporation for antenna coil 8 for example is a 5¼″ bay of a personal computer. Furthermore, it is also possible that antenna coil 8 is formed as an external component and that it is connected via a plug-in-type cable connection to electronic device 2. In this case antenna coil 8 can be accommodated for example in an appealingly designed housing, which can be set up separately from electronic device 2.

In FIG. 1 by way of example are shown an RFID reading device 9 and an NFC device 10 as communication partners for the contactless communication with security module 1. RFID here stands for radio frequency identification. NFC stands for near field communication and refers to a data transmission with the help of high-frequency magnetic alternating fields, for example with the frequency 13.56 megahertz. RFID reading device 9 for example is formed according to standard ISO/IEC 14443 and provided with an antenna coil 11. NFC device 10 is provided with an antenna coil 12 and for the communication with passive contactless interface 5 of security module 1 is operated as a reader.

When electronic device 2 is switched on, it provides security module 1 with the required operating voltage, so that security module 1 is operational and for example able to record operational parameters of the electronic device 2 received via device interface 4, to execute cryptographic operations for electronic device 2 etc.

Moreover, the formation of security module 1 shown in FIG. 1 permits an operation of security module 1 even when the electronic device 2 is switched off or because of other reasons does not provide any operating voltage for security module 1. Such an operation of security module 1 independent of electronic device 2 is always possible when antenna coil 8 of security module 1 is located in the area of a sufficiently strong field. In this case the voltage induced in antenna coil 8 and supplied to passive contactless interface 5 can be used as operating voltage for security module 1. A field suitable therefor can be produced with both RFID reading device 9 and NFC device 10 and has for example a frequency of 13.56 megahertz.

In particular, it is provided to always supply security module 1 with the operating voltage provided by electronic device 2, when an operating voltage is provided by electronic device 2. If via electronic device 2 an operating voltage is not available and an operation of security module 1 is still desired, the operating voltage is produced by a contactless energy transmission via antenna coil 8 to passive contactless interface 5.

The passive contactless interface 5 does not only serve the purpose of receiving energy, but also of contactlessly sending and receiving data, preferably with the help of the same fields with which the energy is transmitted. This means, that security module 1 is operational independent of the functional state or operating state of electronic device 2 and in particular is able to communicate with the outside world. This communication can neither be prevented nor manipulated by electronic device 2, so that the transmitted data are very reliable. Preferably, security module 1 is able to carry out a secure communication via passive contactless interface 5, e.g. via a trusted channel. In this way with security module 1 can be realized, for example, a reliable monitoring of electronic device 2 or a reliable protection against the loss of important data. Concrete applications of the security module 1 are described in more detail in the following.

All descriptions regarding the first embodiment also apply to the further embodiments, unless different explanations are given there.

FIG. 2 shows a schematic diagram of a second embodiment of a system having the security module 1. In the second embodiment security module 1 has an active contactless interface 13 instead of the passive contactless interface 5. With that it is possible to additionally provide a contactless chip card 14 as a communication partner for security module 1. As for the rest the second embodiment corresponds to the first embodiment as shown in FIG. 1.

Active contactless interface 13 itself is able to produce a high-frequency magnetic alternating field, for example with the frequency 13.56 megahertz. With that active contactless interface 13 can carry out a communication even when antenna coil 8 is not in a field of a communication partner. This permits for example the communication of active contactless interface 13 with contactless chip card 14, which with respect to its communication capabilities resembles the passive contactless interface 5 of the security module 1 according to the first embodiment. But this requires the supply of energy to security module 1 for operating the active contactless interface 13. This means that an operation of security module 1 and in particular a communication via active contactless interface 13 is only possible when electronic device 2 supplies a sufficient operating voltage to security module 1.

Active contactless interface 13 for example is formed as an NFC interface and then has similar communication possibilities as NFC device 10. For communicating with the communication partners shown in FIG. 2 active contactless interface 13 is operable in different communication modes. For example, for communicating with RFID reading device 9 the active contactless interface 13 is operated in a communication mode “being card”. In such communication mode active contactless interface 13 behaves like a card and communicates for example according to standard ISO/IEC 14443 with RFID reading device 9. For communicating with NFC device 10 active contactless interface 13 is operated in a communication mode “peer to peer”, i.e. a communication between communication partners of the same kind takes place. Finally, for communicating with contactless chip card 14 there is provided a communication mode “being reader”, with which active contactless interface 13 behaves like a reading device and communicates for example according to standard ISO/IEC 14443 or ISO/IEC 15693.

Active contactless interface 13 thus offers more communication possibilities than passive contactless interface 5. But active contactless interface 13 is only usable when electronic device 2 supplies security module 1 with an operating voltage, whereas passive contactless interface 5 permits an operation of security module 1 independent from electronic device 2. All these advantages jointly exist in a further embodiment, which is shown in FIG. 3.

FIG. 3 shows a schematic diagram a of third embodiment of a system having the security module 1. In the third embodiment security module 1 has both the passive contactless interface 5 of the first embodiment and the active contactless interface 13 of the second embodiment, which are connected in parallel and can be selectively operated. Here security module 1 has a first switching device 15, a second switching device 16 and a voltage detector 17. The first switching device 15 depending on the switching state either connects security unit 3 with passive contactless interface 5 or with active contactless interface 13. The second switching device 16 depending on the switching state either connects antenna coil 8 with passive contactless interface 5 or with active contactless interface 13. Voltage detector 17 monitors the operating voltage supplied to security module 1 by electronic device 2 and controls the two switching devices 15 and 16. When voltage detector 17 detects a sufficient operating voltage, it actuates the two switching devices 15 and 16 in such a way that security unit 3 and antenna coil 8 each are connected with active contactless interface 13. In this case the functionalities described for the second embodiment are available. When, however, voltage detector 17 detects a too low operating voltage, it actuates the two switching devices 15 and 16 in such a way that security unit 3 and antenna coil 8 each are connected with passive contactless interface 5. In this case the functionalities described for the first embodiment are available.

FIG. 4 shows a schematic diagram of a fourth embodiment of a system having the security module 1. Security module 1 is formed in a fashion corresponding to the first embodiment as shown in FIG. 1. The electronic device 2, in which security module 1 is incorporated, has a software stack 18, a system software 19 and an application software 20 and is connected with network 7.

In addition, in FIG. 4 is shown a further electronic device 21, which contactlessly communicates with security module 1 of electronic device 2. Such further electronic device 21 has an RFID reading device 9 with an antenna coil 11, an NFC device 10 with an antenna coil 12, a security unit 22, a device interface 23, a software stack 24, a system software 25, an application software 26 and a keyboard 27. Via RFID reading device 9 or NFC device 10 further electronic device 21 can contactlessly communicate directly with passive contactless interface 5 of security module 1 of electronic device 2.

In the described embodiments for the systems having the security module 1 there is a plurality of possibilities to use the capabilities of security module 1, in particular the capability of the direct contactless data transmission. In the following several possible applications are described by way of example. If in these applications it is required to ensure an operativeness of the security module 1 independent of the state of the electronic device 2, there will be used one of the security modules 1 with passive contactless interface 5 as shown in the FIGS. 1, 3 and 4. Alternatively, security module 1 with active contactless interface 13 as shown in FIG. 2 can be used, which is only operational when electronic device 2 supplies it with an operating voltage.

In a first application passive contactless interface 5 is used for producing a backup of the data of security module 1. This application in particular is of interest, when electronic device 2 is no longer operable, because, for example, the power supply is defect or another hardware malfunction or software error occurred. Likewise, there could also have occurred a manipulation of software 6 or system software 19 or application software 20, so that these are no longer trustworthy.

In the first application, for example, the further electronic device 21 shown in FIG. 4 communicates with security module 1 with the help of RFID reading device 9 or of NFC device 10 via passive contactless interface 5. After a successful authentication the data of security unit 3 are transmitted to further electronic device 21 and stored there. These data, for example, can be keys for cryptographic algorithms, such as asymmetric RSA keys for encrypting or decrypting and/or creating a signature of data, or they can be passwords. The data transmitted from security module 1 can be stored in security unit 22 of further electronic device 21 or are transmitted into a security module of another operable and trustworthy electronic device. If keys for encrypting hard disks or keys for encrypting such keys are read out, these can be used to decrypt encrypted data stored on memories of the electronic device 2. In case of a defect electronic device 2 such data would not be restorable without another backup mechanisms.

A second application is that with the help of RFID reading device 9 or of NFC device 10 diagnosis data of electronic device 2 are read out from security module 1 via passive contactless interface 5. Diagnosis data can be measuring data about the system state, e.g. BIOS, operating system, application. The measuring data are measured according to the concept of the TCG during the boot process of electronic device 2 and stored in security unit 3 in so-called platform configuration registers (PCR). An authorized user can readout the measuring data directly from such PCRs. A defect or manipulated system software 19 or application software 20 cannot prevent the passing on of the measuring data to the authorized user. With these reliably preserved PCR data the user, for example an administrator, can determine, which areas of the software 6 or the system software 19 or the application software 20 are still trustworthy and which areas are not trustworthy. The readout of the measuring data from security module 1 is even possible in case of a total failure of the electronic device 2.

A third application relates to the secure acquisition and the secure storage of service claims. Such service claims can be a ticket for public transport, an admission ticket or other money-equivalent services. The service claims can be reliably loaded into security module 1 for example via network 7. For this purpose special protocols are provided by the TCG, such as a TLS connection in line with the TCG provisions. The payment process can be effected with the help of RFID reading device 9 or NFC device 10 via passive contactless interface 5 of security module 1. For this purpose, preferably, a secure transmission is carried out via a secure channel. Such a secure channel can be established with the help of RFID reading device 9 or NFC device 10, security unit 22 and software stack 23.

A fourth application relates to the secure entering of the password via keyboard 27 or another input unit of further electronic device 21, the password being transmitted with the help of RFID reading device 9 or NFC device 10 via passive contactless interface 5 to security unit 3 of electronic device 2. The contactless transmission permits a direct transmission path. With that the risk of passwords being spied out by the possibly manipulated system software 19 or application software 20 of electronic device 2 is decreased. In a development the transmission of the password can also be effected through a cryptographically secured channel between electronic device 2 and further electronic device 21. The secure channel can be established according to the concepts of the TCG in particular with the help of security units 3 and 22.

A fifth application relates to the copy protection of a portable data carrier, e.g. a CD. The portable data carrier here is formed such that it contains a contactless data carrier, which can communicate, analogous to the contactless chip card 14 shown in FIG. 2, via active contactless interface 13 with security module 1. Here rights can be managed with the help of special protective mechanisms, which prevent an unauthorized reproduction of the rights. Such a protective mechanism can be realized for example with the help of a controlled-access read command. The read command allows that special data, such as rights for listening to a piece of music, are copied only when subsequently the rights are deleted from electronic device 2. In case of defect electronic devices 2 in this way the rights could be secured without there existing a danger of misusing an unauthorized reproduction.

A further possible protective mechanism includes the storage of security-critical data, which are deposited on the portable data carrier and security module 1 of electronic device 2, when a software is installed. With the help of the deposited data an unauthorized reproduction of the data of the portable data carrier can be prevented.

A sixth application is the secure transmission of large data amounts. Here security module 1 of electronic device 2 exchanges only security-critical data, such as a key, with the security module of another electronic device via passive contactless interface 5 or active contactless interface 13. In this application the security modules 1 also assume the task of encrypting the large data amounts and decrypting them after the transmission via a fast interface, such as IRDA or WLAN.

A seventh application is to link a plurality of electronic devices 2, which each are provided with a security module 1, to form groups. For example, it would be conceivable, that mobile telephones and fixed network telephones, and further electronic devices 2, e.g. a PDA, are members of a group. The determination of the group membership, but in particular the communication between the electronic devices 2 of a group, is effected via security modules 1. Within a group actions can be carried out, which cannot be carried out with electronic devices 2 outside the group. E.g. a data synchronization can take place, or data of other electronic devices 2 can be read upon request. A user of a fixed network connection e.g. then could have access to the telephone numbers stored on his mobile telephone without switching it on. So that it is impossible to corrupt data by a defect or manipulated electronic device 2, a password mechanism of security unit 3 can be used. Here critical data are “encrypted” with the password via an HMAC and are only readable when the password is correctly entered.

Besides the described applications there exist many further application possibilities for systems having the security module 1. In each of the applications at least one electronic device 2 has a security module 1. The communication partner of the electronic device 2 can also have a security module 1 with security unit 3, device interface 4 and passive contactless interface 5 or active contactless interface 13. In this case there can also be provided a direct communication between the security modules 1 of the electronic device 2 and the communication partner. Likewise, it is also possible that the communication partner only has a security unit 3 and a pertinent device interface 4 or even has no TPM protection at all.

1-21. (canceled)

22. A system, comprising
a first electronic device,
a security module, which is firmly bound to the first electronic device and has a security unit for either or both securely storing data and executing cryptographic operations and a first interface for communicating with the first electronic device, and
a second electronic device, wherein the security module has a second interface arranged to autonomously execute a direct contactless communication with the second electronic device.

23. The system according to claim 22, wherein the first interface is galvanically connected with the first electronic device.

24. The system according to claim 22, wherein the second interface is formed as an integral part of the security unit.

25. The system according to claim 22, wherein the second interface is formed as a passive contactless interface.

26. The system according to claim 25, wherein the passive contactless interface is arranged to contactlessly supply energy required for the operation of the security module.

27. The system according to claim 22, wherein the second interface is formed as an active contactless interface.

28. The system according to claim 27, wherein the active contactless interface is operable in different communication modes.

29. The system according to claim 22, wherein the security module includes a passive contactless interface and an active contactless interface.

30. The system according to claim 29, wherein the security module includes a control device arranged to selectively activate the passive contactless interface or the active contactless interface.

31. The system according to claim 30, wherein the control device effects the activating dependent on whether an operating voltage from the first electronic device is supplied to the security module.

32. The system according to claim 27, wherein the active contactless interface is formed according to the NFC Standard.

33. The system according to claim 22, including an arrangement enabling transmission of data stored in the security unit to the second electronic device via the second interface.

34. The system according to claim 33, wherein the data are diagnosis data of the first electronic device or cryptographic data.

35. The system according to claim 33, wherein the arrangement enabling transmission of the data is configured so that the data are transmitted only when the first electronic device and the second electronic device are members of a group of electronic devices, for which a data transmission between one another was released.

36. The system according to claim 22, wherein the second electronic device includes a security module which directly contactlessly communicates with the security module of the first electronic device.

37. The system according to claim 22, wherein cashless payment transactions are effected via the second interface, with which authorizations stored in the security unit are acquired.

38. The system according to claim 22, wherein a password entered into the second electronic device is transmitted via the second interface to the security module of the first electronic device.

39. The system according to claim 22, wherein the first electronic device is a computer or a mobile telephone.

40. The system according to claim 22, wherein the second electronic device is selected from the group consisting of an RFID reading device, an NFC device, a contactless chip card, a computer and a mobile telephone.

41. The system according to claim 22, wherein the security module is formed as a trusted platform module.

42. An electronic device with a security module, which is firmly bound to the electronic device and has a security unit for either or both securely storing data and executing cryptographic operations and a first interface for communicating with the electronic device, wherein the security module has a second interface for autonomously carrying out an external contactless communication independent of the electronic device.
